(19) United States
(12) Patent Application Publication
(10) Pub. No.: US 2013/0041984 A1
(43) Pub. Date: Feb. 14, 2013

(54) Electronic Book Rental System and Method

(71) Applicant: Charles McCoy, Prestonburg, KY (US)

(72) Inventor: Charles McCoy, Prestonburg, KY (US)

(21) Appl. No.: 13/206,647

(22) Filed: Aug. 10, 2011

(51) Int. Cl. G06F 15/16

(52) U.S. Cl. 709/219

(57) ABSTRACT

A system and method for providing a E-book on a loan basis comprising: a database for storing a plurality of e-books, where said database is accessible via a computer network; software embedded within each e-book, where said software limits the time period for review of said e-book; and a plurality of end users, where each end user accesses the database via the computer network by using an electronic computing device to download a desired e-book from the database. In the preferred embodiment, the computer network is the Internet. End users may utilize a laptop computer, a desk top computer or an electronic reader to access and store the e-books retrieved from the database.

### BACKGROUND OF THE INVENTION

1. Field of Invention

The present invention relates to electronic book rental system and method to facilitate electronic book rentals via the Internet.

2. Description of Related Art

Many readers enjoy books both in a traditional hardback or paperback style. However, recently many books have been converted to electronic digital media that is equivalent to the printed text. The digital E-book is commonly used on various devices currently in use. Most electronic books or E-books may be read from a personal computer or a handheld device specifically designed for a person viewing an E-book. Some E-books include specific software that may be used for formatting the E-book and many electronic books are available via the Internet. Some retailers such as Amazon® or Barnes and Noble® have developed specific devices for E-books such as the Amazon Kindle or the Barnes and Noble Nook to supply electronic books. Further Apple has recently developed a multifunctional device called the iPad that also provides an opportunity for the distribution of E-books.

E-books provide many advantages to the reader in that the book is stored electronically and the data or text related to the book may be reviewed via a computer screen where text may be enlarged to accommodate individuals that may have difficulty reading small text. Further, the E-book doesn't demand paper and thus the use of E-books can have a positive effect on the environment. Further for the distributor, the distribution of the book is cheaper and easier and provides some authors with the opportunity to self-publish books that are downloadable.

Many E-books include digital rights management software that may restrict the reproduction and the sharing of the E-books with other users and helps to protect copyright issues that are related to publication and distribution. One advantage however of traditional printed matters is that many individuals may take the time to access the book from a library and therefore borrow the book temporarily until the book is read and returned to the library. It would therefore be advantageous to have an electronic system that facilitates the loaning of electronic books that includes digital rights management software that may limit access time to an E-book. Such a scheme of distribution could help reduce the cost of E-books over a period of time and allow individuals to access E-books on a loan-type basis.

### SUMMARY OF THE INVENTION

The present invention relates to a system and method for providing a E-book on a loan basis comprising: a database for storing a plurality of e-books, where said database is accessible via a computer network; software embedded within each e-book, where said software limits the time period for review of said e-book; and a plurality of end users, where each end user accesses the database via the computer network by using an electronic computing device to download a desired e-book from the database. In the preferred embodiment, the computer network is the Internet. End users may utilize a laptop computer, a desk top computer or an electronic reader to access and store the e-books retrieved from the database.

### BRIEF DESCRIPTION OF DRAWINGS

FIG. 1 depicts a monitor with a display of an electronic book according to the present invention.

FIG. 2 depicts a system of distribution of electronic books that include time period limitations.

### DETAILED DESCRIPTION

The present invention relates to the system and method of electronic book distribution that includes software that limits the review time period for an electronic book. The present invention implements a time sensitive stamp on an E-book and therefore provides the E-book on a loan basis that is electronically administered through software embedded in the E-book. The present invention enables users to access E-books on a loan basis and therefore functions similarly to an electronic library where the user is allowed to review the E-book over a period of time. The time limited software embedded in the E-book deletes and/or disables the book after a period of time, therefore preventing the user from having unlimited use of the E-book. The software further limits further distribution of the E-book to other users.

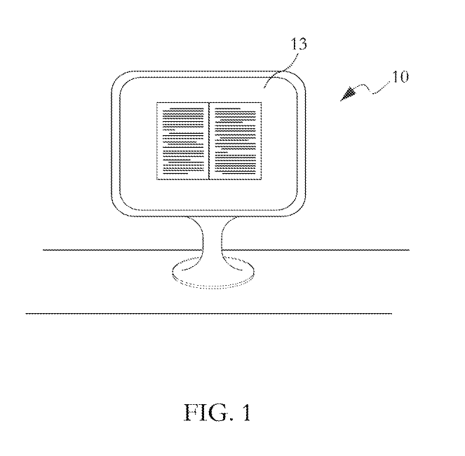

FIG. 1 depicts a Monitor 10 that includes a Display 13 of an electronic book. As noted above, electronic books are displayed on laptop computers, desktop computer monitors or e-readers that are specifically designed for the review of E-books. An E-book reader may download the E-book via the Internet and then a user may review the book on the display monitor such as Display 13 of the Monitor 10.

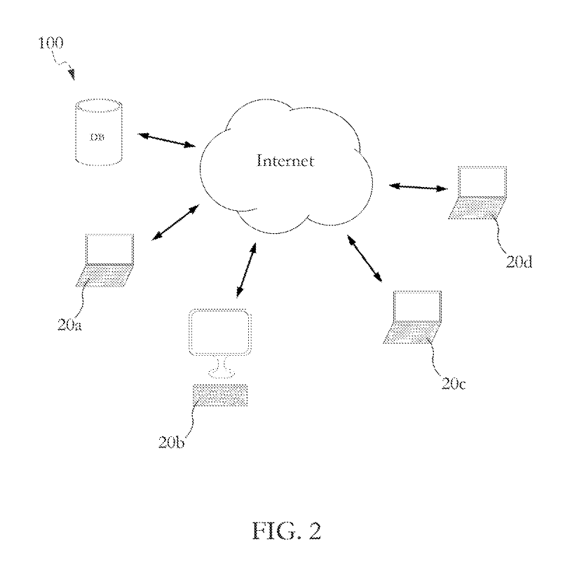

FIG. 2 depicts a system and method contemplated by the present invention. The system and method according to the present invention includes a Database 100. The Database 100 stores a plurality of electronic books. The Database 100 connects to Internet 50 where the Internet 50 provides a means for distribution of the electronic books to End Users 20a through 20d as shown in FIG. 2. Although the Internet 50 is depicted in FIG. 2, the E-books may be distributed through any computer network where any authorized users connect and interact over the network. The E-books that are stored on the Database 100 include software that is implemented and downloaded to the end user on their individual computer or electronic device. The software coincides with software embedded in the electronic book that places a time period limitation on the review of the electronic book downloaded by the Database 100. This system therefore includes software embedded in the electronic book and software that's downloaded by the user to read the electronic book.

An end user, in order to access the electronic books, accesses the Database 100 via the Internet 50. The end user may first review the selection and categories of E-books stored on the Database 100, and then elect to review a particular book of interest. After selection of the desired E-book, the user submits payment for the time rental of the E-book. Upon acceptance of the payment and payment method, the Database 100 allows for the downloading of the E-book via the Internet 50 to the end user. Once the E-book is downloaded and provided to the end user, the end user may then review the book over the time period provided and associated with the E-book. Upon acceptance of the E-book for download, a review time period begins upon the review of the book by the end user. The end user may receive an alert at a predetermined time that the end of the review period is about to elapse in order to provide notice that the E-book may be returned to the Database 100 or the E-book will be disabled and deleted from the end user's computer via the software residing on the end user's computer for review of the E-book.

The E-book may be stored in a conventionally known documenting format such as an Adobe Acrobat PDF, JPEG or otherwise. The files may be limited to read only files and the user should not be able to make notations or other edits to the E-book itself. However the alert should provide notice that the loan period of user is about to expire and functions with the software residing on the end user's computer. The alert may also be posted on calendaring software residing on the user's computer such as Microsoft Outlook® or iCalendar™.

Use of the E-book loan system according to the present invention therefore enables the user to receive an E-book for a limited time period and provide a means to review the book without purchasing the book for unlimited use. The lending service therefore functions similar to a library and allows the end user the flexibility to review an E-book at a reduced cost as opposed to purchasing the E-book for unlimited use. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for providing a E-book on a loan basis comprising:
a. a database for storing a plurality of e-books, where said database is accessible via a computer network;
b. software embedded within each e-book, where said software limits the time period for review of said e-book; and
c. a plurality of end users, where each end user accesses the database via the computer network by using an electronic computing device to download a desired e-book from the database.

2. The system according to claim 1, where said computer network is the Internet.

3. The system according to claim 1, where said computing device includes at least one of a laptop computer, a desk top computer and a electronic reader.

4. A method obtaining a E-book comprising the steps of:
a. connecting to a computer network;
b. selecting a time limited e-book from a plurality of e-books residing on a database;
c. downloading the selected time limited e-book for storage into memory residing on an electronic computing device; and
d. reviewing the e-book for a predetermined time period.

5. A method of providing a E-book comprising the steps of:
a. storing a plurality of e-books on a database;
b. connecting the database to a computer network;
c. embedding time sensitive software onto each e-book;
d. allowing end users access to the database via the computer network;
e. transferring time sensitive software to each end user;
f. limiting access to each e-book for a predetermined time period; and
g. terminating access to each e-book after expiration of the predetermined time period through use of the embedded time sensitive software.
